(19) United States
(12) Patent Application Publication
(10) Pub. No.: US 2002/0047460 A1
(43) Pub. Date: Apr. 25, 2002

(54) Electric power steering apparatus

(75) Inventors: Atsuhiko Yoneda, Wako-shi (JP); Hisao Asaumi, Wako-shi (JP); Hidenori Kurahashi, Sayama-city (JP); Takashi Kuribayashi, Wako-shi (JP); Yasuo Shimizu, Wako-shi (JP)

Correspondence Address: MERCHANT & GOULD PC, P.O. BOX 2903, MINNEAPOLIS, MN, 55402-0903, US

(73) Assignee: Honda Giken Kogyo Kaisha

(21) Appl. No.: 09/818,138

(22) Filed: Mar. 27, 2001

(30) Foreign Application Priority Data
Mar. 27, 2000 (JP) 2000-086417

(51) Int. Cl. H02K 1/00

(52) U.S. Cl. 310/216

(57) ABSTRACT

An electric power steering apparatus is disclosed which includes an electric motor having less cogging to thereby provide a comfortable steering feel. The electric motor includes an annular outer stator and an inner rotor positioned within the outer stator. The outer stator has circumferentially arranged stator windings of nine or a multiple of nine poles. The inner rotor has circumferentially arranged permanent magnets of eight poles. The permanent magnets are radially magnetized, and have N and S poles alternately arranged circumferentially. Three or a multiple of three poles of the stator windings are connected in series and driven by three-phase electric power.

### BACKGROUND OF THE INVENTION

1. Field of the Invention

The present invention relates generally to an electric power steering apparatus for motor vehicles and, more particularly, to an electric power steering apparatus for applying an assist torque to a steering system of the motor vehicle.

2. Description of the Related Art

In recent years, electric power steering apparatuses have been widely used in motor vehicles with a view to lighten steering load of a steering wheel for thereby providing a comfortable steering feel. The electric power steering apparatus of this type usually includes an electric motor for applying an assist torque, corresponding to a steering torque, to a steering system, a typical example of which is disclosed in Japanese Patent Laid-Open Publication No. HEI-9-30432 entitled “Electric Power Steering Apparatus”.

In the disclosed electric power steering apparatus, a steering torque generated by turning a steering wheel is transmitted to a pinion shaft of a rack-and-pinion mechanism. An electric motor produces an assist torque, corresponding to the steering torque, to be transmitted through a friction coupling and a worm gear mechanism to the pinion shaft for steering steerable wheels. A rotor of the electric motor is held in constant drive connection with the pinion shaft through the worm gear mechanism.

In the electric power steering apparatus thus arranged, when a steering torque exerted to the steering wheel is small, the electric motor does not produce an assist torque and the steerable wheels are steered merely with a steering torque. When a steering torque exceeds a given level, the electric motor produces an assist torque to be added to the steering torque so that the steerable wheels can be steered by the combined steering and assist torque. In the event the electric motor is held in a halt due to a low steering torque, the steering torque is used both for steering the steerable wheels and for turning a rotor of the electric motor.

When the motor vehicle travels linearly at a high speed, a steering angle of the steering wheel is relatively small and the steerable wheels have a small steered angle with tread portions of tires deformed only slightly. Thus, the tires encounter low frictional resistance (hereinafter referred to as “road reaction force”) arising between the tires and a road surface. As the road reaction force decreases, the steering torque of the steering wheel decreases, thus rendering an assist torque needless.

Upon steering the steerable wheels by merely a torque resulting from turning the steering wheel a small angle in a range close to a neutral position of the steering wheel, it is desirable that that torque is held substantially constant in magnitude because this will provided an improved steering feel.

When fluctuations in the steering torque are larger than those of a road reaction force due to certain factors, it is difficult for a vehicle driver to distinguish the fluctuations of the steering torque from the fluctuations of the road reaction force. Presence of the large fluctuations in the steering torque has a detrimental effect on steering smoothness upon turning the steering wheel to make a slight course change. Addressing this kind of detrimental effect provides improved steerability of the motor vehicle.

A main factor why, when the steering wheel is turned near the neutral position and the steerable wheels are steered merely with the steering torque, fluctuations in the steering torque increases is derived from a specific structure of the electric motor coupled to the pinion shaft.

As disclosed in Japanese Patent Laid-Open Publication No. HEI-9-30432, the electric motor of the electric power steering apparatus comprises a brush dc motor. Such an electric motor is typically comprised of an annular stator composed of a plurality of permanent magnets circumferentially arranged in a case, and a rotor disposed in the stator and having armature windings.

In general, when the armature windings are de-energized, cogging occurs between respective magnetic poles of the stator and respective cores of the armature windings. Cogging is multiplied by a square of a reciprocal of gear reduction ratio of a worm gear mechanism, and the multiplied cogging is then transmitted as fluctuations to the steering wheel through the pinion shaft. The steering torque thus involves fluctuations.

A typical example of an electric motor for reducing cogging is known from Japanese Patent No. 2,967,340 entitled “Permanent Magnet Synchronous Motor”.

The aforementioned synchronous motor is a so-called outer rotor synchronous motor which comprises an annular yoke (corresponding to an outer rotor) mounted on a rotary shaft, and a stationary armature core disposed in the yoke. The armature core includes nine radially-arranged salient poles each having a winding. On an inner periphery, the yoke has eight circumferentially-arranged magnetic poles. Thus, the electric motor is a synchronous motor having nine salient poles and eight permanent magnets.

Since the electric power steering apparatus disclosed in Japanese Patent Laid-Open Publication No. HEI-9-30432 is to be positioned in a narrow space of the motor vehicle, it should be as small as possible. The electric motor should also be as small as possible. However, the electric motor must be designed to have high power output for application to the power steering apparatus. In contrast, the electric motor disclosed in Japanese Patent No. 2,967,340 encounters a problem in that since permanent magnets are employed with a large number of windings surrounded by a yoke, the yoke inevitably becomes large in diameter, thus limiting downsizing of the electric motor.

Furthermore, in the electric power steering apparatus disclosed in Japanese Patent Laid-Open Publication No. 9-30432, since an assist torque is produced responsive to a steering torque of the steering wheel in frequent times to suitable extents, the rotor of the electric motor should have as small inertia as possible. Since, in this event, inertia of the rotor is transmitted to the steering wheel with a force equal to a value proportionate to the square of the reciprocal of the gear reduction ratio of the worm gear mechanism, lowering inertia of the rotor provides a comfortable steering touch or feel. In contrast, in the synchronous motor disclosed in Japanese Patent No. 2,967,340, the yoke has a large diameter due to the inherent structure of the permanent magnet type synchronous motor, thus limiting reduction in inertia of the rotor.

Thus, in view of the difficulties experienced in the reduction of the size and inertia of the electric motor, the aforementioned permanent magnet synchronous motor cannot be employed as it is.

The electric motor of the usual type includes the armature windings distributed and wound in more than two slots, with a relatively large portion of the armature windings having no contribution to formation of effective magnetic flux with resultant increased copper losses. Consequently, the electric motor should need a further considerable research and development in order to provide an increased power output.

### SUMMARY OF THE INVENTION

It is therefore an object of the present invention to provide a small-sized electric power steering apparatus which can provide a comfortable steering touch or feel by minimizing torque fluctuations caused by a de-energized electric motor during linear travel of a motor vehicle employing the electric motor.

Another object of the present invention is to provide an electric power steering apparatus wherein an electric motor produces increased power output to provide improved steerability.

According to one aspect of the present invention, there is provided an electric power steering apparatus including an electric motor for applying a steering assist torque, corresponding to a steering torque, to a steering system, the electric motor comprising: an annular outer stator having circumferentially arranged stator windings of nine or a multiple of nine poles; and an inner rotor positioned within the outer stator and having circumferentially arranged permanent magnets of eight poles, the stator windings being connected such that they can be driven by electric power of three phases.

The least common multiple of nine poles of the stator windings and eight poles of the permanent magnets is 72 which is relatively large. In general, the larger the least common multiple becomes, cogging (magnetic attraction) of the electric motor decreases.

In a preferred form, the outer stator comprises nine or a multiple of nine salient poles radially arranged at an equal pitch. The salient poles have respective stator windings wound therearound, with three or a multiple of three poles of the stator windings being connected in series to provide three phases. With each of the nine or multiple of nine salient poles being wound by the stator windings, it becomes possible to prevent overlapping of the nine or multiple of nine stator windings. This leads to the advantage that the electric motor has a reduced number of winding portions which do not contribute to the formation of effective magnetic flux, thereby reducing copper losses and hence avoiding decrease in power output.

Desirably, each of the three phases comprises those three or a multiple of three poles of the stator windings which are not positioned adjacent to each other, connected in series. Thus, mutual inductance of the stator windings, which are not positioned adjacent to each other, remains at a small value.

Each of the three phases may comprise those three or a multiple of three poles of the stator windings which are positioned adjacent to each other, connected in series.

It is preferred that the eight poles of the permanent magnets are magnetized radially so that N and S poles are alternately positioned circumferentially.

### BRIEF DESCRIPTION OF THE DRAWINGS

Certain preferred embodiments of the present invention will be described in more detail below, by way of example only, with reference to the accompanying drawings in which:

FIG. 1 is a schematic view of an electric power steering apparatus according to a preferred embodiment of the present invention;

FIG. 2 is a schematic view illustrating a basic principle of a steering torque sensor shown in FIG. 1;

FIG. 3 is a view illustrating an example arrangement of a steering system shown in FIG.1;

FIG. 4 is a cross-sectional view taken along line 4-4 of FIG. 3;

FIG. 5 is a cross-sectional view taken along line 5-5 of FIG. 4,illustrating an electric motor, a torque limiter and a geared reduction mechanism;

FIG. 6 is a cross-sectional view taken along line 6-6 of FIG. 5, illustrating the electric motor;

FIG. 7 is an enlarged partial cross-sectional view of the electric motor shown in FIG. 6, illustrating an outer stator and an inner rotor;

FIG. 8 is an exploded perspective view illustrating the whole arrangement of the electric motor;

FIGS. 9A and 9B are schematic views respectively illustrating wiring connection of stator windings wound around salient poles shown in FIG. 6, and an equivalent circuit of the electric motor;

FIG. 10 is a graph showing a relationship between the number of poles of the stator windings and the number of poles of permanent magnets in relation steering smoothness a steering wheel; and

FIG. 11 is a schematic diagram of a modified form of the stator windings of the electric motor according to the present invention.

### DETAILED DESCRIPTION OF THE PREFERRED EMBODIMENTS

The following description is merely exemplary in nature and is in no way intended to limit the invention, its application or uses.

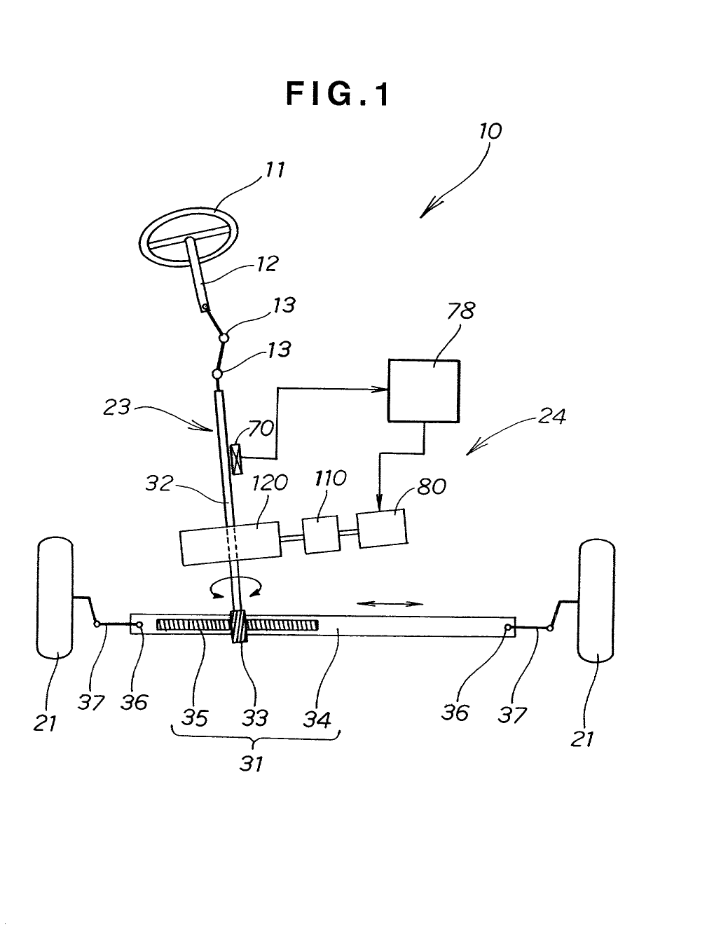

Referring initially to FIG. 1, an electric power steering apparatus 10 includes a steering system 23 coupled between a steering wheel 11 of a motor vehicle and front wheels 21, 21 of the motor vehicle, and a steering assist mechanism 24 designed to exert a steering assist torque to the steering system 23.

The steering system 23 includes a steering shaft 12 coupled to the steering wheel 11, first and second universal joints 13, 13, and a pinion shaft 32 which is coupled to the steering shaft 12 via the first and second universal joints 13, 13 and forms a rack-and-pinion mechanism 31. The rack-and-pinion steering mechanism 31 includes a rack shaft 34, which is connected at its both distal ends to the front wheels 21, 21 via ball joints 36, 36 and tie rods 37,37. The rack-and-pinion mechanism 3l is comprised of the pinion shaft 32 whose lower distal end is formed with a pinion 33, and the rack shaft 34 formed with toothed rack 35.

The steering assist mechanism 24 includes a steering torque sensor 70, positioned in close proximity to the pinion shaft 32, for detecting a steering torque exerted thereto by turning the steering wheel 11 and producing a steering torque signal representing the detected steering torque, a controller 78 for producing a control signal in response to the steering torque signal, and an electric motor 80 for producing, in response to the control signal, an assist torque corresponding to the steering torque. The produced assist torque is applied through a torque limiter 110 and a geared reduction mechanism 120 to the pinion shaft 32.

The thus-arranged electric power steering apparatus 10 enables steering of the road wheels 21, 21 by a composite torque consisting of a steering torque produced by turning the steering wheel 11 and a steering assist torque of the electric motor 80.

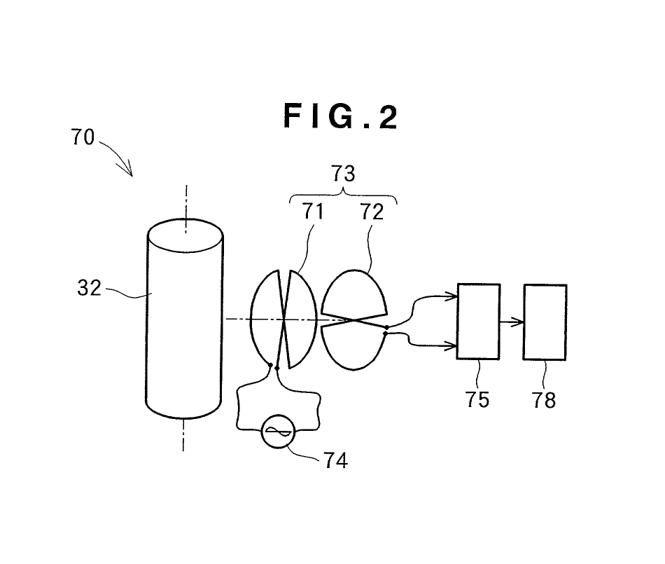

FIG. 2 is a schematic diagram illustrating a basic principle of an operation of the steering torque sensor 70 shown in FIG. 1. The steering torque sensor 70 comprises a magnetostrictive torque sensor which includes an electric coil for detecting magnetic distorsion caused by a steering torque produced in the pinion shaft 32 made of metallic material such as iron steel having the magnetostrictive characteristic responsive to the steering torque imparted thereto and for converting mechanical energy into electrical energy. The magnetostrictive torque sensor comprises a known one as disclosed in, for example, Japanese Patent Laid-Open Publication No. HEI-6-221940 entitled “Magnetostrictive type torque sensor”. The steering torque sensor 70 will be described in detail below.

The steering torque sensor 70 includes an excitation coil 71 formed in a substantially 8-shaped profile, and a detection coil 72 formed in a substantially 8-shaped profile and dimensioned in the same size as the excitation coil 71. The excitation coil 71 and the detection coil 72 intersect one another at a substantially right angle in concentric relation, thereby forming one set of magnetic heads 73 which are located in close proximity to an outer periphery of the pinion shaft 32. In particular, the excitation coil 71 formed in the 8-shaped profile is mounted on the outer periphery of the pinion shaft 32, and the detection coil 72 formed in 8-shaped profile is overlapped on the excitation coil 71 at an angle shifted 90 degrees in phase. During this assembling operation, the linear portion of the 8-shaped profile of the excitation coil 71 is placed on the outer periphery of the pinion shaft 32 in substantially parallel to the outer periphery of the pinion shaft 32 or in substantially parallel to a longitudinal axis of the pinion shaft 32. Reference numeral 74 designates a source of excitation voltage for applying an excitation voltage to the excitation coil 71. Reference numeral 75 designates a voltage amplifier.

The excitation voltage source 74 is arranged to supply excitation voltage to the excitation coil 71 at a high frequency of about 20 to 100 KHz. The detection coil 72 produces an output voltage, at the same output frequency as the excitation voltage, which varies in response to the magnetostrictive effect produced in the pinion shaft 32 responsive to the steering torque exerted by the steering wheel.

The output voltage may have two polarities, that is, the same phase or the opposite phase relative to the excitation voltage depending on the direction of the steering torque exerted on the pinion shaft 32. The amplitude of the output voltage is proportionate to the magnitude of steering torque. Thus, by utilizing the phase of the excitation voltage as a reference to rectify the output voltage in synchronism with the excitation voltage, it is possible to detect both the amplitude and direction of the steering torque in a highly reliable manner. The output voltage is applied to and amplified in the voltage amplifier 75, producing the steering torque detection signal. The controller 78 is responsive to the steering torque detection signal and produces the driver assist torque control signal.

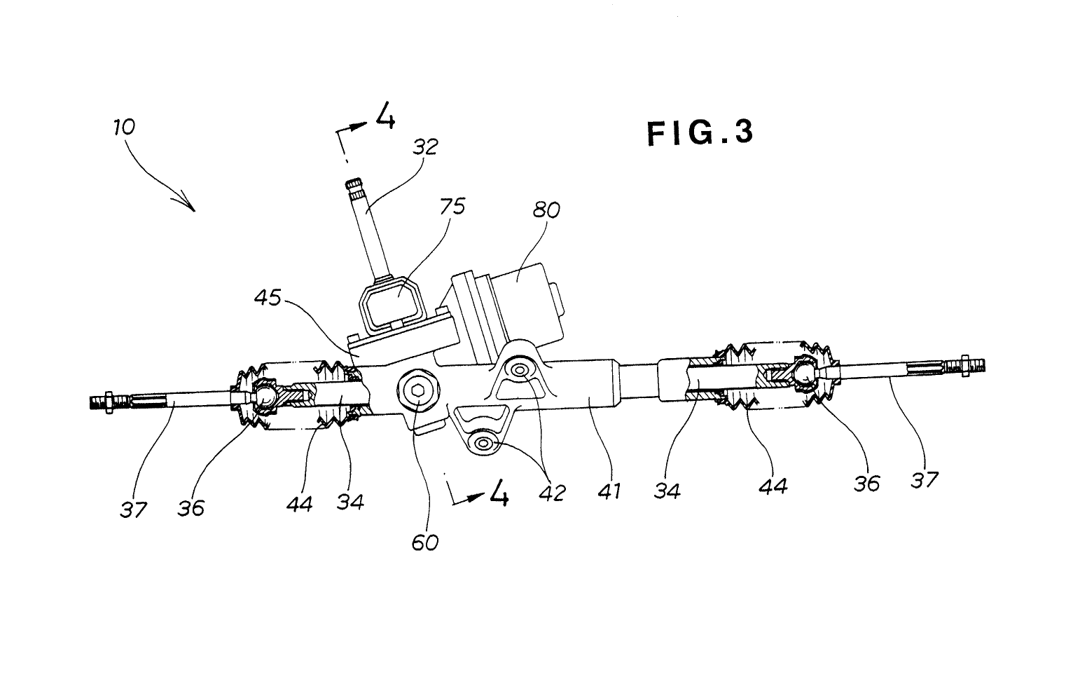

Reference is made next to FIG. 3 showing, partly in section, the electric power steering apparatus 10 according to the present invention. The rack shaft 34 of the electric power steering apparatus 10 is axially disposed in a housing 41 for sliding movement therein, which extends in a lateral or widthwise direction (that is, right-and-left direction in FIG. 3) of the motor vehicle.

The rack shaft 34 has opposed distal ends coupled to respective ball joints 36, 36, which are connected to the right and left tie rods 37, 37, respectively. The housing 41 has two brackets 42, 42 which are to be mounted to the vehicle body not shown. Reference numerals 44, 44 designate dust seal boots.

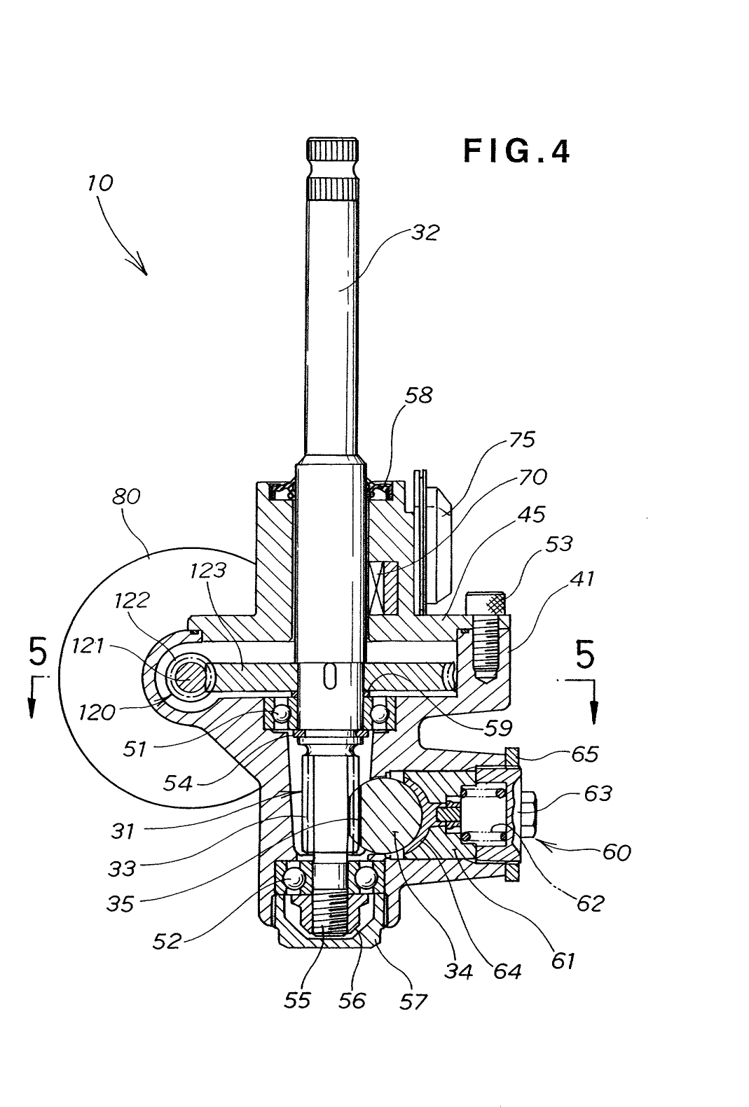

FIG. 4 illustrates a longitudinally sectioned structure of the electric power steering apparatus 10.

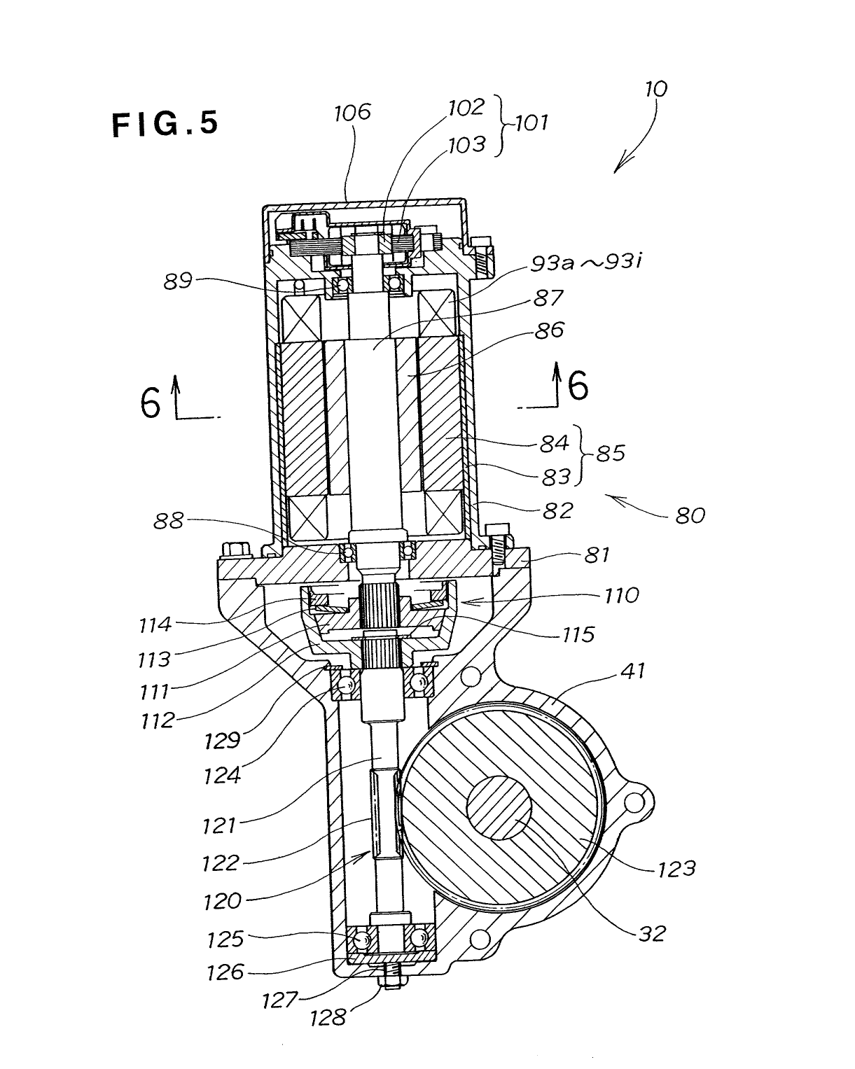

The housing 41 of the electric power steering apparatus 10 incorporates therein the rack and pinion mechanism 31, the steering torque sensor 70, the torque limiter 110 (see FIG. 5) and the reduction gear mechanism 120, with an upper opening of the housing 41 being covered with a lid 45. In FIG. 4, the steering torque sensor 70 is shown as being incorporated in the lid 45 but may be directly incorporated into the housing 41. The housing 41 and the lid 45 are coupled together by means of fastening bolts 53.

The housing 41 has upper and lower bearings 51 and 52 for rotatably supporting a central portion and a lower end portion of the pinion shaft 32, respectively. Reference numeral 60 designates a rack guide, whilst reference numeral 54 designates a retaining ring.

A lower portion of the pinion shaft 32 has a pinion 33, with a distal end of the pinion shaft 32 being formed with a threaded portion 55 while an upper portion of the pinion shaft 32 extends outward from the lid 45. A nut 56 is screwed onto the threaded portion 55, thereby delimiting axial or longitudinal movement of the pinion shaft 32. Reference numeral 57 denotes a cap nut. Reference numeral 58 designates an oil seal. Designated by reference numeral 59 is a spacer.

The rack guide 60 includes a guide member 61 and an adjusting bolt 63. The guide member 61 is arranged to urge the rack shaft 34 in a direction opposite to the rack 35 formed on the rack shaft 34. The adjusting bolt 63 functions to adjust the urging force of a spring 62 that urges the guide member 61 toward the rack shaft 34 at a predetermined force. With the rack guide 60 thus arranged, the position of the adjusting bolt 63 is adjusted relative to the housing 41 such that the guide member 61 is urged toward the rack shaft 34 with a suitable urging force to cause the guide member 61 to pressurize the rack 35 which is consequently urged toward the pinion 33. Reference numeral 64 designates an arcuate batten element while reference numeral 65 designates a lock nut.

FIG. 5 is a cross-sectional view illustrating a relationship between the electric motor 80, the torque limiter 110 and the reduction gear mechanism 120.

A side opening of the housing 41 is covered with a lid 81 which is fixed in place with fastening bolts. The electric motor 80 has a motor case 82 which is fixedly mounted on the lid 81. The motor case 82 has a hollow, cylindrical member formed with a bottom wall. A first annular outer stator 83 is fitted to the motor case 82. A second annular outer stator 84 is fitted to the first annular outer stator 83. A cylindrical inner rotor 86 is rotatably disposed in the second annular outer stator 84. The inner rotor 86 has a motor shaft (i.e., an output shaft) 87. A rear end of the motor shaft 87 supports a phase detection sensor 101 for detecting phase of the inner rotor 86. The electric motor 80 is a brushless, inner-rotor DC motor. The first and second outer stators 83 and 84 form the outer stator 85.

A front portion of the motor shaft 87 extends in the housing 41. The motor shaft 87 is rotatably supported with the lid 81 and the motor case 82 by means of bearings 88, 89.

The phase detection sensor 101 includes a laminated core rotor 102 fixedly secured to the rear distal end of the motor shaft 87, and a detection element 103 (which is constructed of combined excitation coil and detection coil) for magnetically detect the phase of the core rotor 102. Reference numeral 106 designates a cover.

The torque limiter 101 includes an inner member 111 for engaging with the motor shaft 87 by spline connection, and a cup-shaped outer member 112 coupled to the worm shaft 121 by spline connection. The inner member 111 is held in engagement with the outer member 112, with a resultant friction caused between an outer periphery of the inner member 111 and an inner periphery of the outer member 112 to provide a driving connection.

When the torque limiter 110 encounters a larger torque exceeding a given frictional force, slip takes place between the outer periphery of the inner member 111 and the inner periphery of the outer member 112. When this occurs, the magnitude of a steering assist torque exerted on the reduction gear mechanism 120 from the electric motor 80 is limited to provide protection from over-torque. Consequently, the electric motor 80 is protected from excessive overload, thereby preventing excessive overload to be imparted to load side. Reference numeral 113 designates a dish spring while reference numeral 114 designates a nut. Designated by reference numeral 115 is a retaining ring.

The reduction gear mechanism 120 functions as a torque delivery unit which transmits the steering assist torque, produced by the electric motor 80, to the pinion shaft 32 and includes a worm gear mechanism. In particular, the gear reduction unit 120 includes a worm shaft 121 coupled to the motor shaft 87 of the electric motor 80 via the torque limiter 110, a worm 122 formed on an outer periphery of the worm shaft 121, and a worm wheel 123 (hereinafter referred to merely as a wheel) coupled to the torque limiter 32.

A lead angle between the worm 122 and the wheel 123 is designed such that it is slightly larger than that of a friction angle. This is due to the fact that, during a turned-off (de-energized) condition of the electric motor 80, the steering torque produced by the pinion shaft 32 allows the motor shaft 87 of the electric motor 80 to rotate via the wheel 123, the worm 122, the worm shaft 121 and the torque limiter 110.

The worm shaft 121 is aligned on the motor shaft 87 in concentric relationship, and is supported with first and second bearings 124, 125 in the housing 41. The first bearing 124, closest to the motor shaft 87, is fixedly supported in the housing 41 and is disenabled to move in an axial direction. The second bearing 125, remotest from the motor shaft 87, is fitted in the housing 41 so as to allow the worm shaft 121 to move in the axial direction relative to the housing 41.

The second bearing 125 is forcibly urged with a disc shaped, plate spring 126, held in contact with a terminal end of an outer race of the second bearing 125, toward the motor shaft 87. The urging force of the disc shaped, plate spring 126 is adjusted with an adjusting bolt 127. In such a structure, the urging force is determined with the adjusting bolt 128 and the disc shaped, plate spring 126 to provide a given preliminary pressure between the first and second bearings 124, 125, leaving no play, a so-called shake, in the axial direction. Also, an axial position of the worm 122 can be adjusted such that the worm 122 and the wheel 123 are maintained in a meshing condition to keep a suitable, frictional property while preventing the shake. Also, owing to the urging force of the plate spring 126, it is possible to absorb a thermal expansion of the worm shaft 121 in the axial direction. Reference numeral 128 designates a lock nut and reference numeral 129 designates a retainer ring.

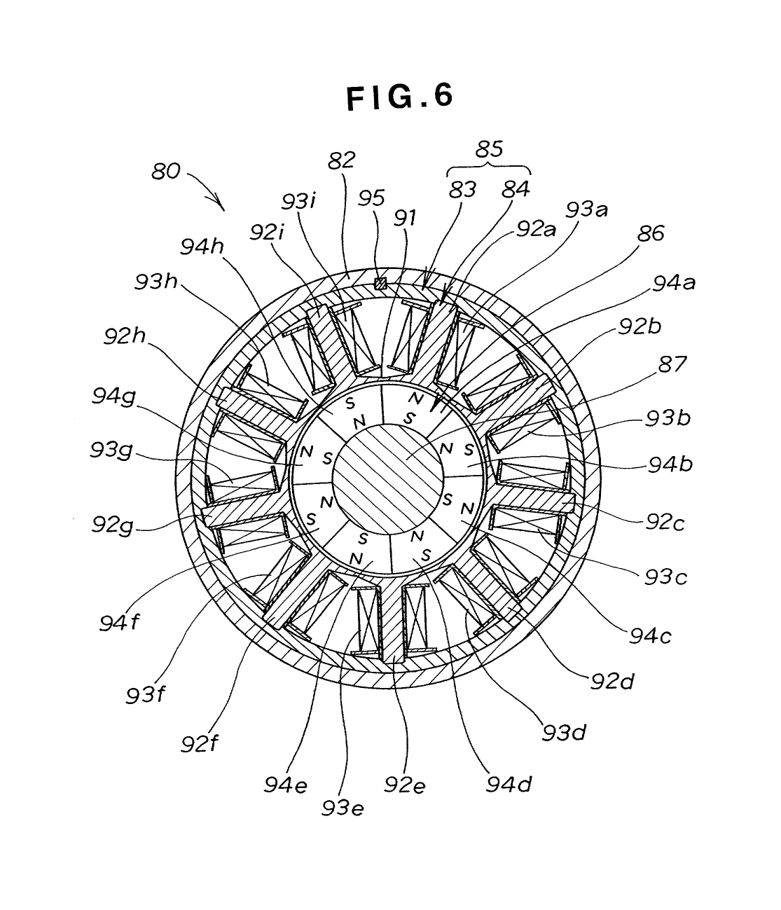

A detailed structure of the electric motor 80 is described below with reference to FIGS. 6 to 8.

In FIG. 6, the second outer stator 84 includes a magnetic material having nine salient poles 92a to 92i which radially extend from a hollow cylindrical section at equidistantly spaced locations. These salient poles 92a to 92i have stator windings 93a to 93i, respectively. Each of these salient poles 92a to 92i includes a stack of thin magnetic plates.

The inner rotor 86 is constructed having a rotor body including eight permanent magnets 94a to 94h which are arranged in a circumferential direction. Each of these permanent magnets 92a to 92h has an arc-shape, with N and S poles located in a radial direction and also alternately arranged in a circumferential direction.

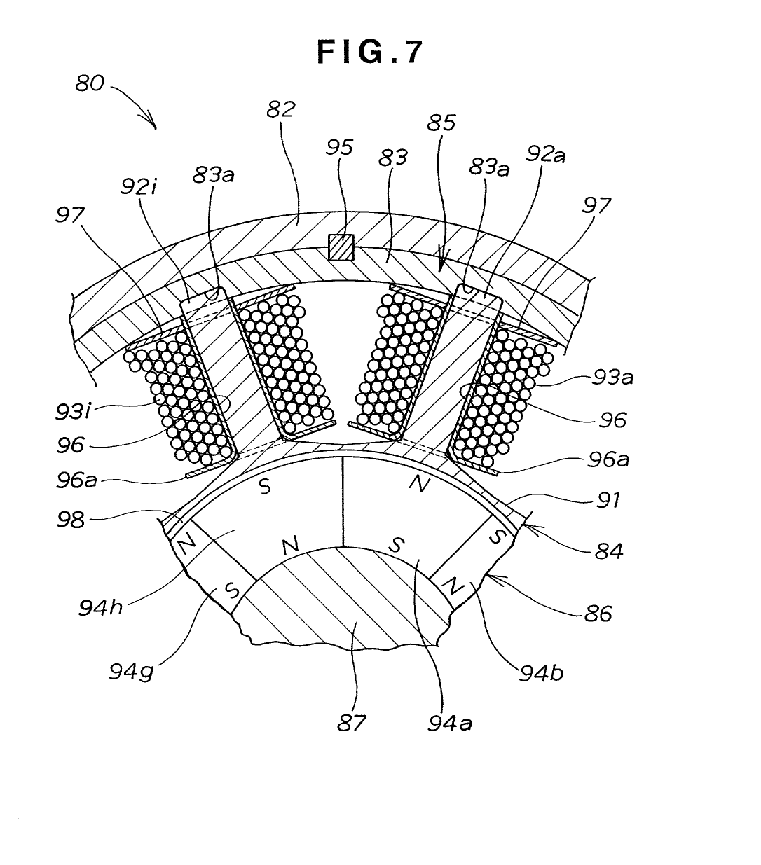

In FIG. 7, the first outer stator 83 is positioned in a fixed place in the circumferential direction relative to the motor case 82 with a positioning pin 95. An inner periphery of the first outer stator 83 if formed with a plurality of equidistantly spaced recesses 83a to receive respective radial ends of the plural salient poles 92a to 92i. These plural recesses 83a extend in an axial direction. Consequently, the second outer stator 84 is positioned in a fixed place relative to the first outer stator 83 in a circumferential direction. As a result, the respective salient poles 92a to 92i are precisely located incorrect positions relative to the mounting position of the phase detection sensor 101 (see FIG. 5).

Each of the stator windings 93a to 93i is wound around a cylindrical bobbin 96 whose bottom is formed with an annular flange 96a. A retaining plate 97 is press fitted to a radial end of each cylindrical bobbin 96. Each of the bobbins 96 thus provided with the respective stator windings 93a to 93i is inserted into each of the stator poles 92a to 92i. In this manner, the stator windings 93a to 93i are formed on the respective salient poles 92a to 92i.

A small air gap 98 is defined between an inner periphery of the cylindrical section 91 of the second outer stator 84 and an outer periphery of the inner rotor 86.

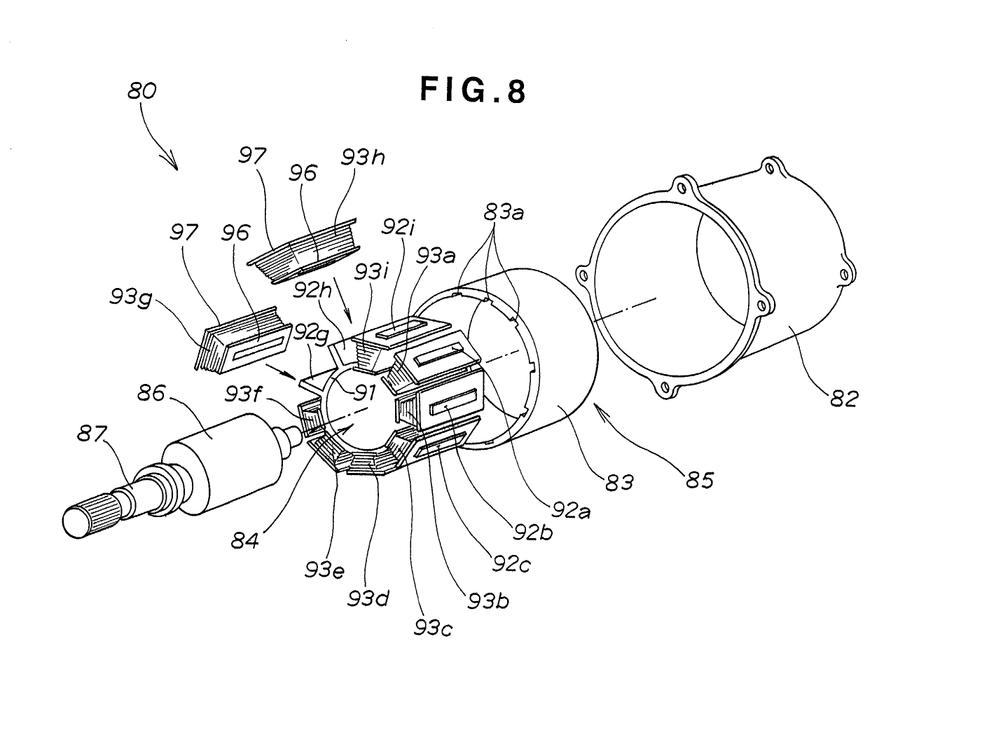

An assembling sequence of the electric motor 80 is described below with reference to FIG. 8. In a first step, individual bobbins 96 having the respective stator windings 93a to 93i thereon are each inserted to each of the salient poles 92a to 92i. In a subsequent step, the second outer stator 84 is inserted to the first outer stator 83, with a resultant assembly of the annular outer stator 85 having the nine stator windings 93a to 93i arranged in the circumferential direction. In a next step, the outer stator 85 is inserted to the motor case 82, thereby mounting the outer stator 85 into the motor case 82.

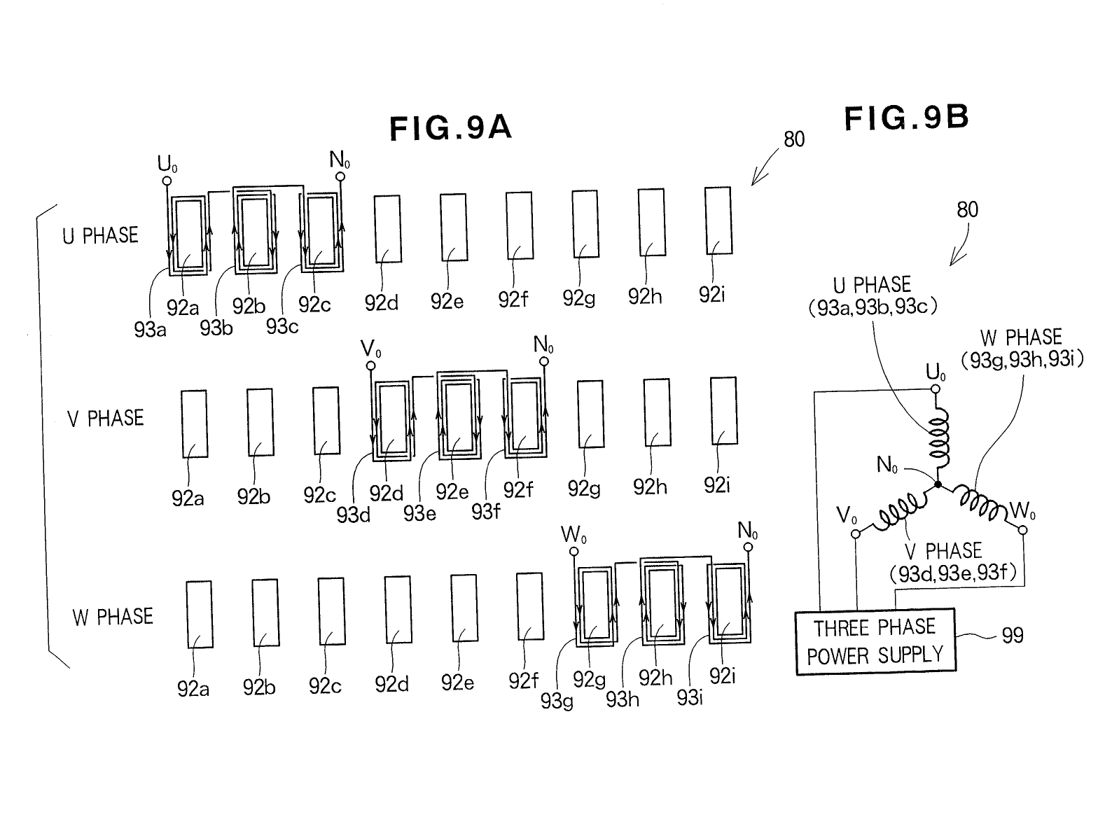

FIGS. 9A and 9B show a typical wiring pattern according to the present invention.

As shown in FIG. 9A, three adjacent stator wirings 93a, 93b, 93c, wound around the respective stator poles 92a, 92b, 92c, are connected in series to form a single phase, which forms part of three phases (U-phase, V-phase and W-phase).

More specifically, the U-phase is formed with the three adjacent stator windings 93a, 93b, 93c connected in series, the V-phase is formed with three adjacent stator windings 93d, 93e, 93f connected in series, and the W-phase is formed with three adjacent stator windings 93g, 93h, 93i connected in series. The stator windings 93a to 93i are wound in the same direction as viewed in FIG. 9A.

An input terminal of the U-phase stator winding bears a reference numeral Uo and an output terminal bears a reference numeral No. Likewise, an input terminal of the V-phase stator winding bears a reference numeral Vo and an output terminal bears a reference numeral No. An input terminal of the W-phase stator winding bears a reference numeral Wo and an output terminal bears a reference numeral No.

It will now be understood from the foregoing description that the stator windings of the electric motor 80 are composed of concentrated stator windings wherein the stator windings 93a to 93i are wound around the respective nine salient poles 92a to 92i radially extending and equidistantly spaced from one another in the circumferential direction. As a result, the nine stator windings 93a to 93i are not mutually overlapped with one another.

Consequently, the stator windings of the electric motor 80 are arranged such that there is no stator winding lying across plural slots as in distributed stator windings wound around in more than two slots. As a consequence, since the electric motor 80 has less amount of stator winding portion which does not contribute to form an effective magnetic flux, copper loss is remarkably reduced, increasing power output to cause the electric motor 80 to produce a high mechanical output.

By employing the aforementioned electric motor 80 with less copper loss and with high power output in the electric power steering apparatus 10 (see FIG. 1), the electric power steering apparatus has various advantages. In general, under conditions where the engine's rotational speed is low with the motor vehicle in its halt condition, such as in a case where the motor vehicle is put into a garage, an electric power generator driven by the engine produces low power output. The present invention makes it possible to cause the electric motor 80 to produce a steering assist torque in quick response and in a highly reliable manner as shown in FIG. 1 even when power output of the electric power generator is low. Consequently, steering response nature for the wheels 21, 21 can be highly improved especially when quick turning of the steering wheel is needed, thus increasing steerability.

FIG. 9B shows an electrical connecting diagram illustrating the electric motor 80 formed in a Y-connection (Star-connection) by interconnecting the respective neutral terminals No of the U-phase, V-phase and W-phase stator windings to one another and interconnecting the input terminals Uo, Vo and Wo of the U-phase, V-phase and W-phase windings to respective output terminals of a three-phase power supply 99. In this manner, the respective stator windings 93a to 93i of the electric motor 80 are connected to and driven with three-phase electric power.

The electric motor 80 is controlled in a sequence, for example, in a pulse width modulation mode to apply pulse voltages to the respective terminals Uo, Vo and Wo from the three-phase power supply 99. The pulse width of each pulse voltage is controlled in response to the control signals delivered from the controller 78 shown in FIG. 1, causing the electric motor 80 to produce a desired steering assist torque responsive to the steering torque.

Here, the reason why the electric motor 80 employed in the electric power steering apparatus 10 is constructed of the outer stator 85 having the stator windings 93a to 93i and the inner rotor 86 having the permanent magnets 94a to 94h of eight poles is described in detail with reference to FIG. 1 and FIGS. 6 and 10.

As previously discussed with reference to FIG. 6, the electric motor 80 comprises the DC brushless motor in which the stator includes the salient poles 92a to 92i and the stator windings 93a to 93i, and the rotor 86 includes the permanent magnets 94a to 94h.

In general, when the motor vehicle is traveling linearly during turning-off state of the stator windings 93a to 93i of the electric motor 80 a cogging problem (magnetic attraction) arises between each of the salient poles 92a to 92i and each of the permanent magnets 94a to 94h. Cogging is amplified to a value equal to a product multiplied by square of the reciprocal of a reduction ratio in the reduction gear mechanism 120, and is delivered as amplified fluctuations to the steering wheel 11 through the pinion shaft 32. Thus, the steering torque tends to fluctuate.

In the electric power steering apparatus 10 shown in FIG. 1, when the motor vehicle is running straight in a forward direction during turned-off state of the electric motor 80, the presence of the fluctuations in the steering torque caused by cogging effect of the electric motor 80 must be minimized to obtain a comfortable steering touch or feeling. To this end, the cogging effect must be desirably reduced.

The number of cogging times produced per each revolution of the rotor 86 equals to a value corresponding to the least common multiple between the number of the salient poles 92a to 92i (the number of the poles defined by the stator windings 93a to 93i) and the number of the permanent magnets 94a to 94h. However, it has been found that, as the least common multiple increases, the cogging effect is reduced. In order to increases the least common multiple with a view to reducing the cogging effect, it is a good practice to increase the number of the permanent magnet poles 94a to 94h and the number of the poles of the stator windings 93a to 93i.

Since the electric power steering apparatus 10 should be incorporated in a narrow space in the motor vehicle, the electric power steering apparatus 10 should have small size in structure. To this end, the electric motor 80 should also be small in size. Further, the electric motor 80 of the electric power steering apparatus 10 should have a high power output. For example, in an actual practice, the electric motor with a diameter of about 50 to 70 mm is employed and is applied with electric current of about 30 to 40 amperes. Since the electric motor 80 is thus small in size, a large number of stator windings 93a to 93i may be desirably arranged on an area outwardly of the rotor 86.

Since the electric motor 80 is the DC brushless motor, it is a usual practice to drive the stator windings 93a to 93i with the three-phase electric power. The second outer stator 84 may have three poles or the number of pole pieces equal to the multiple of three.

In addition, since the electric power steering apparatus 10 provides the steering assist torque in a frequent and suitable manner in dependence on the steering torque exerted by the steering wheel, inertia of the rotor 86 of the electric motor 80 must be reduced to a level as small as possible. Lowering inertia provides to an improved comfortable steering touch. In order to lower inertia of the rotor 86, the rotor 86 may be light in weight and small in diameter.

In review, in order to employ the electric motor 80 in the electric power steering apparatus 10, a first condition must be med to allow the electric power steering apparatus 10 to be small in size to overcome the limited mounting space in the motor vehicle, and a second condition must also be met to allow the rotor 86, having the permanent magnets, to be reduced in outer diameter with a view to lowering inertia while allowing the stator, having the stator windings, to form the outer stator 85.

The presence of the inner rotor 86 formed with the N and S poles of the permanent magnets 94a to 94i alternately arranged in the circumferential direction essentially provides the number of two poles or the number of pole pieces equivalent to the multiple of two.

As previously noted above, the outer diameter of the inner rotor 86 is determined by taking the limited mounting space of the electric motor 80 in the electric power steering apparatus 10 and the required low inertia into consideration. If, however, the inner rotor has a smaller diameter than is required, it is difficult to increase the number of poles of the permanent magnets 94a to 94h. In order to provide the comfortable steering touch or feeling of the electric power steering apparatus 10, an allowable range of inertia must be initially considered whereupon the diameter of the inner rotor must be preferably addressed.

With such a consideration, when the diameter of the inner rotor 86 is determined, the permanent magnets 94a to 94h arranged on the periphery of the inner rotor 86 may preferably have eight poles to reduce production cost. Although the number of poles of the permanent magnets 94a to 94h can be increased to more than eight, an increase in the number of the permanent magnets may cause an increase in production cost of the electric motor 80. In the illustrated preferred embodiment, the inner rotor 86 has been shown by way of example as having the permanent magnets 94a to 94h of eight poles.

In summary, according to the present invention, the diameter of the inner rotor 86 is determined first to allow the inner rotor 86 to the permanent magnets 94a to 94h of eight poles with a view to improving the cogging performance for thereby providing the comfortable steering touch, second to allow the electric motor 80 to be small-sized with a view to meeting the limited mounting space of the motor vehicle, and third to allow the inner rotor to have low inertia in a range permitted for obtaining the comfortable steering touch.

With such an inner rotor 86 determined to have the permanent magnets 94a to 94h of eight poles, in order to comparatively increase the least common multiple between the number of poles of the permanent magnets 94a to 94h and the number of the stator windings 93a to 93i, the stator is designed to have nine poles of the stator windings 93a to 93i (i.e., nine salient poles 92a to 92i or nine slots). As a result, the least common multiple is 72. Although it is possible for the stator windings 93a to 93i to have more than nine poles, an increase in the number of poles of the stator windings is reflected by an adverse effect on the production cost.

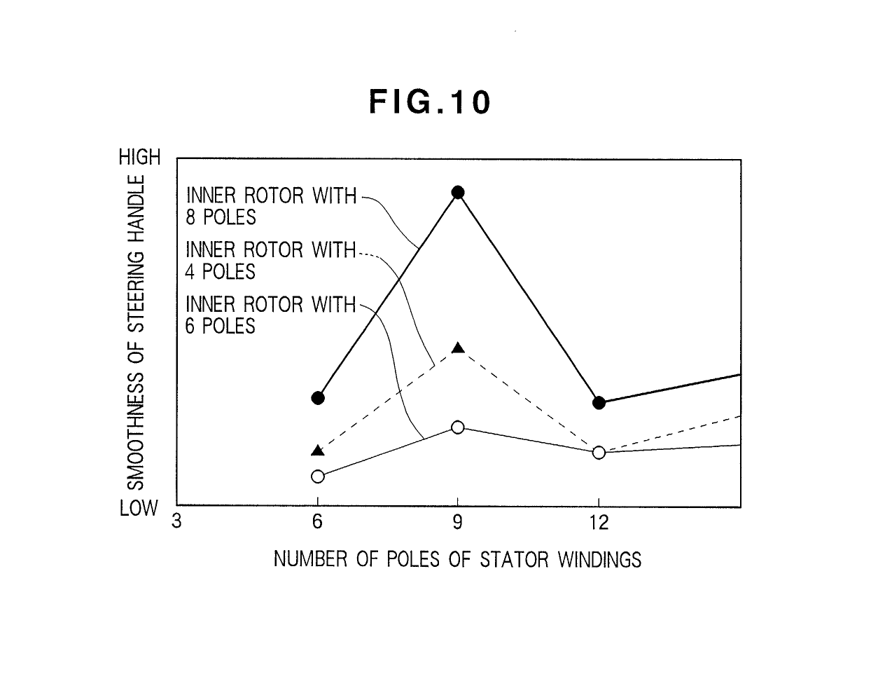

Now, the relationship between the number of poles of the stator windings 93a to 93i of the electric motor 80 and the number of poles of the permanent magnets 94a to 94h, and the smoothness of the steering wheel is described below with reference to a graph of FIG. 10.

When the inner rotor 86 has less than six poles and the number of poles of the stator windings 93a to 93i corresponds to the multiple of three and is less than fifteen, the least common multiple between the number of poles of the permanent magnets 94a to 94h and the number of poles of the stator windings 93a to 93h becomes relatively small.

On the contrary, when the inner rotor 86 has the eight poles and the number of poles of the stator windings corresponds to the multiple of three and is less than fifteen, the least common multiple between the number of poles of the permanent magnets 94a to 94h and the number of poles of the stator windings 93a to 93h becomes relatively large. In particular, when the inner rotor has eight poles and the stator windings 93a to 93i have nine poles, the least common multiple becomes 72 and is larger than the other combination. As the least common multiple increases, the cogging effect decreases. As a result, the cogging effect of the electric motor 80 exerted on the steering wheel decreases, thereby providing steering smoothness in the steering wheel 11 as viewed in FIG. 10. For this reason, the electric power steering apparatus 10 is able to cause the steering wheel 11 to provide a comfortable steering touch or feeling to the vehicle driver.

The above arrangement is a main factor why the electric motor 80 of the electric power steering apparatus 10 is designed to have the outer stator 85 including the nine poles of the stator windings 93a to 93i, and the inner rotor 86 including the eight poles of the permanent magnets 94a to 94h.

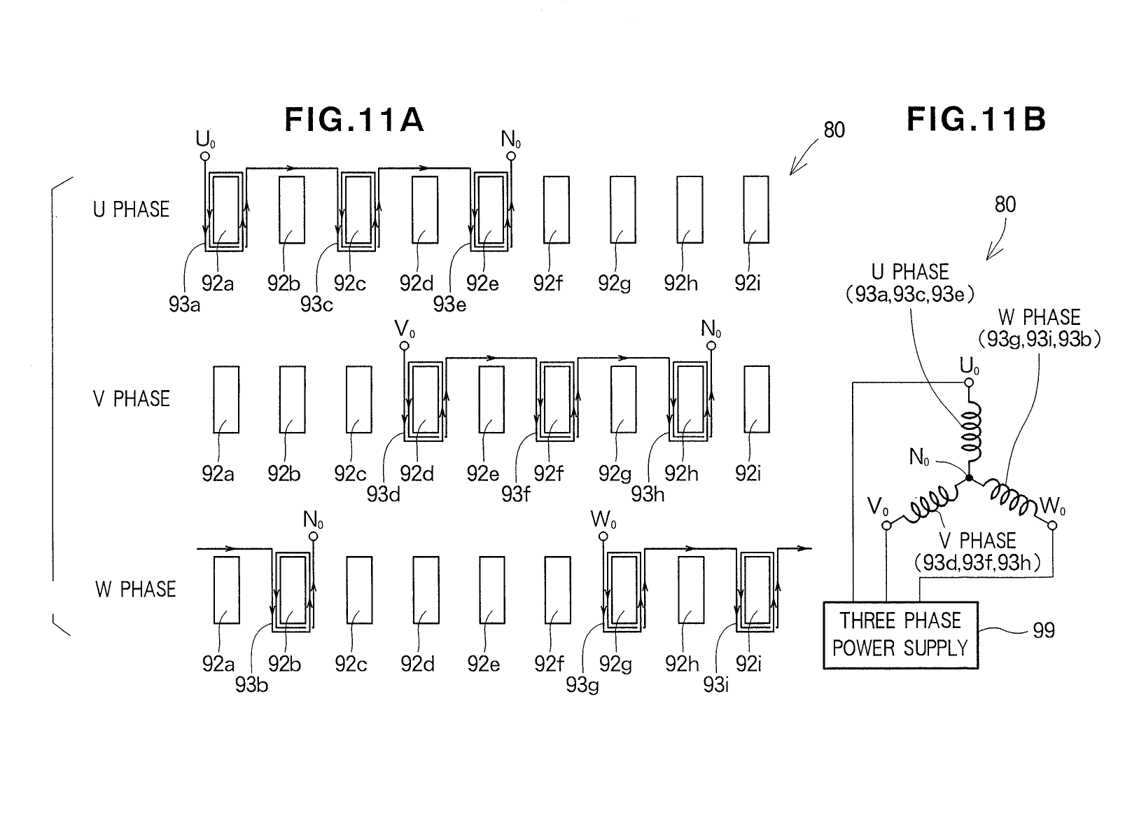

A modified form of the stator windings 93a to 93i is described with reference to FIGS. 11A and 11B.

In FIG. 11A, among the nine stator windings 93a to 93i wound around the nine salient poles 92a to 92i, respectively, each phase is formed with three poles which are not mutually adjacent each other and which are connected in series, thereby forming three phases (i.e., U phase, V phase and W phase).

More specifically, three stator windings 93a, 93c ad 93e, which are not mutually adjacent one another, are connected in series to form the U phase, three stator windings 93d, 93f ad 93h, which are not mutually adjacent one another, are connected in series to form the V phase, and three stator windings 93g, 93i ad 93b, which are not mutually adjacent one another, are connected in series to form the W phase. Consequently, the U, V and W phases are mutually overlapped with each other. All the stator windings 93a to 93i are wound in the same direction as viewed in FIG. 11A.

FIG. 11B shows that the electric motor 80 is connected to form the same Y-connection as shown in FIG. 9B.

With such a modified form of the stator windings of the electric motor 80, since the stator windings 93a, 93c and 93e are not mutually adjacent each other, the mutual inductance of the stator windings 93a, 93c and 93e is small. The effects are the same in the stator windings 93d, 93f and 93h, and the stator windings 93g, 93i and 93b as those of the stator windings 93a, 93c and 93e. Consequently, it is possible to prevent reduction in a steering assist torque produced by the electric motor 80.

In the preferred embodiment discussed above, the outer stator 85 may preferably have circumferentially arranged stator windings 93a of nine poles or the number of the multiple of nine (for example, 18 poles or 27 poles). For example, each stator winding 93a is wound on each of the nine poles or the number of the multiple of nine, with the stator windings of three poles or the stator windings of the number of the multiple of nine being connected in series to provide each phase of three phases.

In addition, the presence of the torque limiter 110 may be arbitrary and, for example, the motor shaft 87 may be extended and may serve as the worm shaft 121.

Furthermore, the gear reduction unit 120 may not be limited to the worm gear mechanism and, for example, may also include a bevel gear mechanism or a spur gear mechanism.

It will now be understood from the foregoing description that, since the electric motor to be employed in the electric power steering apparatus embodying the present invention includes an outer stator having circumferentially arranged stator windings of nine poles or of the number of the multiple of nine and an inner rotor located inside the outer stator and having circumferentially arranged permanent magnets of eight poles, the least common multiple between the number of poles of the stator windings and the number of poles of the permanent magnets can be increased, thereby improving the cogging performance of the electric motor. As a result, when, in the electric power steering apparatus, the steering wheel is steered at a slight steering angle from nearly a neutral position to steer the front wheels merely with the steering torque as in a case wherein the motor vehicle is running straight in a forward direction during the turning-off state of the electric motor, the fluctuations in the steering torque caused by cogging of the electric motor are dumped down, thereby providing a comfortable, smooth steering touch or feeling in the steering wheel.

Since, also, the fluctuations in the steering torque due to the cogging of the electric motor remain in a small range, the driver's hands can feel a delicate variation in a reactive feeling delivered to the steering wheel from road surface through the front wheels, thereby allowing the vehicle driver to catch the exact reaction from road surface by means of the steering wheel in a highly reliable manner. As a result, it is possible to achieve further improved steerability. Moreover, when the steering wheel is steered to change a cruising course by a delicate amount, steering smoothness of the steering wheel almost remains unchanged, with resultant improved steerability.

Further, since the electric motor is constructed having an annular outer stator and an inner rotor located in the outer stator, inertia of the inner rotor can be minimized, providing an improved steering touch or feeling to the steering handle. Also, the presence of a combined structure of the outer stator and the inner rotor allows the electric motor to be small in size, permitting the whole structure of the electric power steering apparatus to be small size in structure to suit for narrow mounting space in the motor vehicle.

Obviously, various minor changes and modifications of the present invention are possible in the light of the above teaching. It is therefore to be understood that with in the scope of the appended claims, the invention may be practiced otherwise than as specifically described.

What is claimed is:

1. An electric power steering apparatus including an electric motor for applying a steering assist torque, corresponding to a steering torque, to a steering system, said electric motor comprising:
an annular outer stator having circumferentially arranged stator windings of nine or a multiple of nine poles; and
an inner rotor positioned within said outer stator and having circumferentially arranged permanent magnets of eight poles;
said stator windings being connected such that they can be driven by electric power of three phases.

2. An electric power steering apparatus according to claim 1, wherein said outer stator comprises nine or a multiple of nine salient poles radially arranged at an equal pitch, each of said salient poles having respective one of said stator windings wound therearound, three or a multiple of three poles of said stator windings being connected in series to provide three phases.

3. An electric power steering apparatus according to claim 2, wherein each of said three phases comprises those three or a multiple of three poles of said stator windings which are not positioned adjacent to each other, connected in series.

4. An electric power steering apparatus according to claim 2, wherein each of said three phases comprises those three or a multiple of three poles of said stator windings which are positioned adjacent to each other, connected in series.

5. An electric power steering apparatus according claim 1, wherein said eight poles of said permanent magnets are magnetized radially so that N and S poles are alternately arranged circumferentially.
